(19) United States
(12) Patent Application Publication
(10) Pub. No.: US 2024/0382385 A1
(43) Pub. Date: Nov. 21, 2024

(54) INTACT PILL DELIVERY SYSTEM

(71) Applicant: The Regents of the University of Colorado, a body corporate, Denver, CO (US)

(72) Inventors: Adam Green, Lafayette, CO (US); Steven Lammers, Lafayette, CO (US); Jennifer Wagner, Aurora, CO (US); Ken Liechty, Denver, CO (US); Jahmel Jordon, Denver, CO (US)

(21) Appl. No.: 18/765,795

(22) Filed: Jul. 8, 2024

Related U.S. Application Data
(63) Continuation of application No. PCT/US2023/010412, filed on Jan. 9, 2023.
(60) Provisional application No. 63/297,335, filed on Jan. 7, 2022.

(51) Int. Cl. A61J 15/00

(52) U.S. Cl. CPC A61J 15/0015

(57) ABSTRACT

A feeding tube configured to allow intact pills to pass through an internal lumen of the feeding tube. Some embodiments of the feeding tube include a main body having a lumen extending between a proximal end and a distal end of the main body. The proximal end includes an inlet aperture leading to the lumen and the distal end includes an outlet aperture fluidically coupled to the lumen. The main body includes a thin-walled transcutaneous section configured to temporarily receive a tubular structural support member that can operate as a traditional feeding tube. The tubular structural support member can be removed to allow a pill delivery device to deliver an intact pill through the lumen and out of the outlet aperture.

### CROSS-REFERENCE TO RELATED APPLICATIONS

This nonprovisional application claims priority to PCT International Application No. PCT/US2023/010412, entitled “Intact Pill Delivery System,” with an international filing date of Jan. 9, 2023, by the same inventors, which claims benefit of provisional application No. 63/297,335, entitled “Intact pill delivery system,” filed on Jan. 7, 2022, by the same inventors.

### BACKGROUND OF THE INVENTION

### 1. Field of the Invention

This invention relates, generally, to medical devices. More specifically, it relates to a medical device configured to deliver an intact pill to a predetermined location within a patient.

### 2. Brief Description of the Prior Art

Feeding tubes are medical devices used to provide nutrition and medicine to individuals incapable of safely swallowing food and medicine. To overcome this problem, feeding tubes are often surgically implanted in a patient's body to directly deliver nutrients and medicine to a predetermined location within the patient's body. In many cases, feeding tubes are vital in keeping the patient healthy and/or alive.

Depending on the placement within the body, feeding tubes are given different names. For example, a percutaneous endoscopic gastrostomy (PEG) procedure is one in which the feeding tube is inserted through the abdominal wall and into the stomach. The feeding tubes used in PEG procedures are often referred to as “PEG tubes” or “G-tubes.”

Because G-tubes require surgical incisions through the patient's body, the diameter of the tubes is minimized to reduce the likelihood of complications associated with larger incisions. The diameter is even further minimized when the patient is a child or baby. In addition, G-tubes are comprised of a fairly rigid material to withstand the ever-present compression forces imposed on the tubes by the surrounding tissue when the tubes are implanted. Due to these considerations, G-tubes are designed to have a relatively small diameter with a relatively thick lateral wall to resist compression.

However, based on these physical properties, G-tubes are too small and inelastic to allow for the passage of intact pills. Thus, patients reliant on G-tubes are often forced to crush their pills or use a liquid alternative as opposed to consuming an intact pill. However, many pills, such as those designed for sustained release, those with an enteric coating, or those containing medicines dangerous or difficult for a human body to process (such as chemotherapy treatments), cannot be crushed or provided in liquid form. In addition, many newer, experimental, or less common medicines have no liquid form because of the expense involved with developing these formulations.

In addition, crushed pills often clog G-tubes, thereby rendering the tubes useless for their intended function by not only providing only a portion of a crushed pill to a subject, but also by reducing the portion of subsequent consumables (including pills, food, and liquids) provided to the subject. G-tubes can also become clogged from the nutrient formula or the patient's stomach contents. In addition, liquid medications often result in clogs in G-tubes, since liquid medications can be viscous and can leave a residue within the G-tube that must be carefully flushed to prevent building and clogging. Unfortunately, it is difficult to unclog G-tubes because they are not easily removed and therefore must be unclogged while still implanted in the patient, thereby requiring an additional medical procedure to remove clogs from the G-tubes.

Accordingly, what is needed is a feeding tube configured to allow for the insertion of intact pills while having a minimal diameter and the ability to withstand the compressive forces of the surrounding tissue to continually operate as a feeding tube. However, in view of the art considered as a whole at the time the present invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an intact pill delivery system is now met by a new, useful, and nonobvious invention.

The novel assembly includes a main body spanning between a proximal end and a distal end. A retaining member is disposed at the proximal end of the main body. The retaining member defines an inlet aperture therethrough. In an embodiment, the retaining member is a handle. An anchor is disposed at the distal end of the main body. The anchor defines an outlet aperture therethrough.

A lumen spans from the retaining member to the anchor. The lumen is secured to the retaining member at a first end and secured to the anchor at an opposing second end.

A feeding tube includes a structural support coupled to a connector cap. The connector cap has an outer diameter greater than an outer diameter of the structural support. The outer diameter of the structural support is less than an inner diameter of the lumen, such that the structural support is selectively receivable within the lumen. The feeding tube is configured to deliver an intact consumable to a subject via the outlet aperture. In an embodiment, a port is defined within the connector cap, with the port having a central axis that is aligned with the inlet aperture.

An embodiment of the assembly includes an asymmetric support secured to the retaining member at a first end and secured to the anchor at an opposing second end. The lumen is received within the asymmetric support. The asymmetric support includes a first half-cylinder and a second half-cylinder. The first half-cylinder is a support section and the second half-cylinder is a fluid flow section. The fluid flow section and the support section together defining a channel therebetween, with the lumen received within the channel. The fluid flow section defines an anchor access channel that is separate from the asymmetric support channel. In an embodiment, the asymmetric support is made of a first material and the lumen is made of a second material, the first material having a greater rigidity than the second material. In an embodiment, the fluid flow section has a greater volume than the support section.

In an embodiment, an access port is defined within the retaining member, with the access port being separate and spaced apart from the inlet aperture. In an embodiment, the anchor access channel defined by the asymmetric support is in fluidic communication with the access port defined by the retaining member.

In an embodiment, an inflation port is defined by the anchor. The anchor access channel is in fluidic communication with the inflation port, thereby creating a closed loop between the access port, the anchor access channel, and the inflation port.

In an embodiment, the anchor includes a retracted configuration in which the anchor has a first outer diameter and an expanded configuration in which the anchor has a second outer diameter, with the second outer diameter being greater than the first outer diameter. An embodiment of the anchor includes an interior compartment that is defined by at least one flexible wall. The interior compartment is configured to increase and decrease in volume based on an input or a removal of fluid from the interior compartment.

An embodiment of the assembly includes a support collar surrounding at least a portion of the lumen. The support collar includes a main body having an outer diameter that is less than an inner diameter of the anchor, such that the inner diameter of the anchor remains constant upon an increase or decrease in volume of the anchor. In an embodiment, the support collar includes a shelf connected to the main body. The shelf has an outer diameter that is greater than the inner diameter of the anchor. The shelf prevents lateral translation of the anchor in a direction toward the retaining member.

An embodiment of the assembly includes a threaded extension disposed at the proximal end of the body, with the threaded extension extending in a direction away from the retaining member. In an embodiment, the connector cap of the feeding tube engages with and secures to the threaded extension.

In an embodiment, the feeding tube is removable from the lumen, and the assembly includes a pill delivery device. The pill delivery device includes a main body having a first outer diameter that is less than the inner diameter of the lumen, such that the main body of the pill delivery device is receivable within the lumen. The pill delivery device also includes a pushing surface disposed at a distal end of the main body. The pushing surface has a biased configuration with a second outer diameter that is greater than the inner diameter of the lumen, and an inserted configuration with a third outer diameter that is less than the inner diameter of the lumen. The pushing surface is configured to receive an intact pill and eject the intact pill through the outlet aperture of the main body upon transformation from the inserted configuration to the biased configuration.

An object of the invention is to provide a feeding tube having an internal lumen that prevents clogging of the tube and reducing any lost medication and/or nutrients. Another object of the invention is to deliver intact medication and nutrients to a subject through a feeding tube.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1A is a perspective view of an intact product delivery assembly showing an anchor in a retracted configuration, in accordance with an embodiment of the present invention.

FIG. 1B is a perspective view of an intact product delivery assembly showing an anchor in an expanded configuration, in accordance with an embodiment of the present invention.

FIG. 2A is an orthogonal view of an intact product delivery assembly showing an anchor in a retracted configuration, in accordance with an embodiment of the present invention.

FIG. 2B is an orthogonal view of an intact product delivery assembly showing an anchor in an expanded configuration, in accordance with an embodiment of the present invention.

FIG. 3 is an exploded view of an intact product delivery assembly, in accordance with an embodiment of the present invention.

FIG. 4 is an orthogonal section view of an intact product delivery assembly, in accordance with an embodiment of the present invention.

FIG. 5 is a perspective view of a feeding tube of an intact product delivery assembly, in accordance with an embodiment of the present invention.

FIG. 6 is a bottom section view of an intact product delivery assembly, in accordance with an embodiment of the present invention.

FIG. 7 is a perspective and section view of an asymmetrical support of an intact product delivery assembly, in accordance with an embodiment of the present invention.

FIG. 8 is a cross-sectional view of an intact product delivery assembly, in accordance with an embodiment of the present invention.

FIG. 9 is an orthogonal view of a support collar of an intact product delivery assembly, in accordance with an embodiment of the present invention

FIG. 10 is an illustration depicting an embodiment of a pill delivery system delivering an intact pill through an embodiment of the present invention.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The phrases “in some embodiments,” “according to some embodiments,” “in the embodiments shown,” “in other embodiments,” and the like generally mean the particular feature, structure, or characteristic following the phrase is included in at least one implementation. In addition, such phrases do not necessarily refer to the same embodiments or different embodiments.

As used herein, “subject” and “patient” are used to describe a human or other animal to whom a tube, such as a feeding tube, is installed to provide a channel through which intact products, such as medications or nutrients, are provided.

The present invention includes an intact product delivery assembly, such as a feeding tube, configured to allow intact pills to pass through an internal lumen. While the present invention may be any type of feeding tube, the provided figures and related descriptions are primarily focused on PEG (or “G-tube”) feeding tubes.

As previously explained herein, minimizing the size of an incision in the patient is critical to avoid complications. As such, traditional PEG feeding tubes have an outer diameter as small as possible to perform their intended functions. In addition, traditional G-tubes have a predetermined wall thickness to ensure that the surrounding tissue from a subject does not occlude the internal lumen of the tube. The wall thickness is also important in preventing spontaneous closures of the gastrocutaneous fistula. The minimized outer diameter coupled with the predetermined wall thickness results in the internal lumen having a predetermined inner diameter that is too small to receive many intact pills. As will be explained in greater detail below, the present invention includes a feeding tube configured to allow intact pills to pass through an internal lumen of the feeding tube.

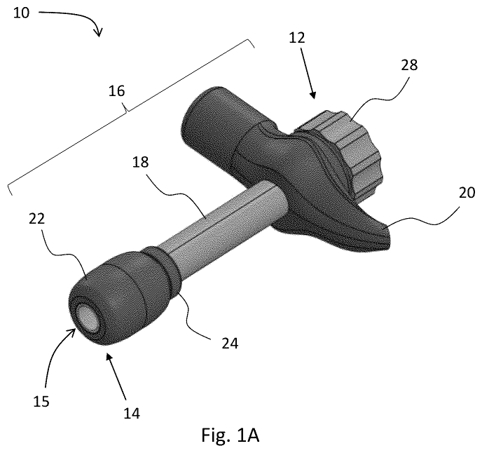

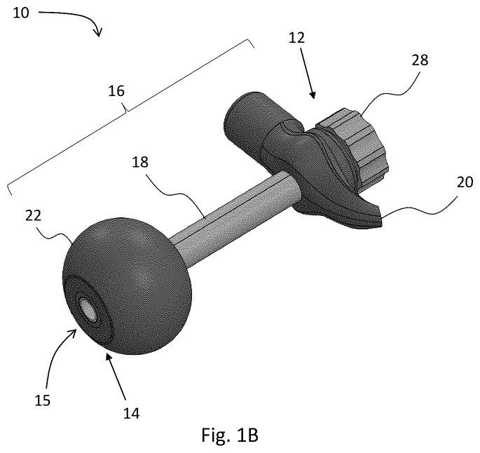

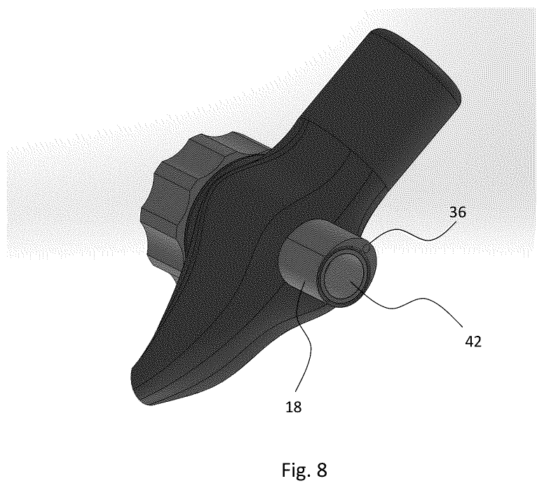

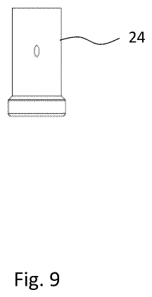

Referring now to FIGS. 1A-10, some embodiments of the present invention include intact product delivery assembly 10 having main body 16 extending between proximal end 12 and distal end 14 of assembly 10. Proximal end 12 includes inlet aperture 13 defined therein and distal end 14 includes outlet aperture 15 defined therein. As such, main body 16 of assembly 10 defines a channel spanning from proximal end 12 to distal end 14, with inlet aperture 13 and outlet aperture 15 defining opposing openings to the channel of main body 16.

As previously stated, embodiments of intact product delivery assembly 10 are configured to allow for the passage of intact pills and nutrients through main body 16. Thus, assembly 10 includes lumen 42 that spans between proximal end 12 and distal end 14 of main body 16. Lumen 42 has an inner diameter sufficiently sized to allow intact pills to pass through lumen 42. In some embodiments, the inner diameter of lumen 42, inlet aperture 13, and/or outlet aperture 15 is between approximately 4 mm and 12 mm. In some embodiments, the inner diameter of lumen 42, inlet aperture 13, and/or outlet aperture 15 is between 4 mm and 8 mm. In some embodiments, the inner diameter of lumen 42, inlet aperture 13, and/or outlet aperture 15 is less than or equal to 7.5 mm. In some embodiments, the inner diameter of lumen 42, inlet aperture 13, and outlet aperture 15 are approximately equal in size. In other embodiments, at least one of lumen 42, inlet aperture, and outlet aperture 15 includes an inner diameter that differs from the inner diameters of the other components.

Feeding tubes must have a minimal outer diameter to minimize the size of the incision in a patient. Given this restriction, the thickness of the lateral walls of lumen 42 are minimized to maintain a minimal outer diameter. While some embodiments of assembly 10 include lumen 42 having an outer diameter generally the same as traditional G-tubes, the wall thickness of lumen 42 is thinner than that of traditional G-tubes, which are typically in the range of approximately 0.8-2 mm thick. In some embodiments, the wall thickness of lumen 42 is between approximately 0.01 mm and 0.12 mm. In some embodiments, the wall thickness of lumen 42 is less than approximately 80 microns.

The wall thickness of assembly 10 results in lumen 42 having a diminished ability to resist the compression forces of tissue surrounding it when implanted. In some embodiments, the minimal wall thickness also requires the use of alternative materials in comparison to traditional G-tubes. For example, lumen 42 can be comprised of ePTFE (such as that marketed under the trade name GORE-TEX™), which is more elastic/compliant/less rigid than the traditional materials (e.g., polyurethane or silicone) of which G-tubes are comprised.

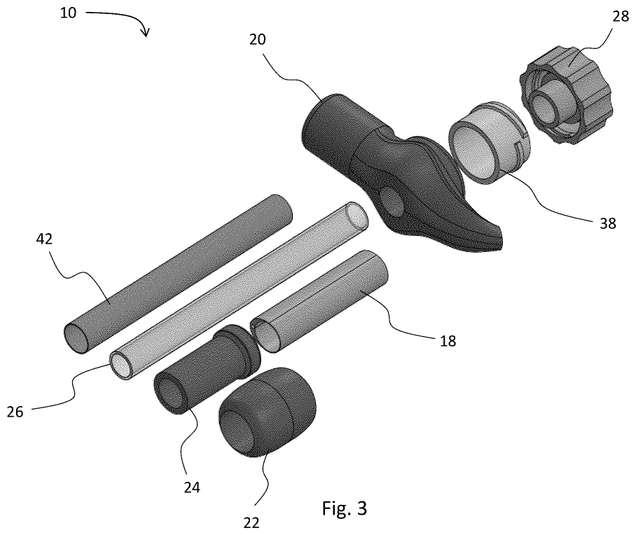

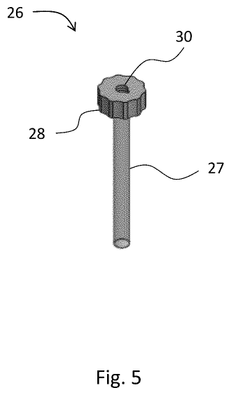

As exemplified in FIGS. 3 and 5, some embodiments of intact product delivery assembly 10 include feeding tube 26 (such as a G-tube) configured to be implanted through a subject's abdominal and stomach walls. Feeding tube 26 is sized and shaped such that feeding tube 26 passes through lumen 42; as such, feeding tube 26 includes an outer diameter that is smaller than an inner diameter of lumen 42, thereby allowing feeding tube 26 to be removably inserted through lumen 42. The main body of feeding tube 26 is therefore configured to extend through an incision in the subject, such that when at least a portion (such as a transcutaneous portion/section of lumen 42) of main body 16 extends through a portion of the subject's tissue, at least a portion of feeding tube 26 also extends through a portion of the subject's tissue.

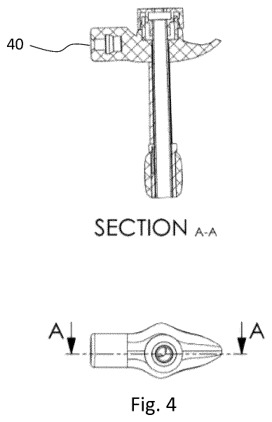

In an embodiment, feeding tube 26 secures to connector cap 28 at a proximal end thereof, such that connector cap 28 is disposed adjacent to proximal end 12 of assembly 10. Connector cap 28 is configured to temporarily engage main body 16 at proximal end 12. As best depicted in FIG. 4, some embodiments include a threaded connector cap 28 configured to threadedly engage threaded neck 38 extending proximally from main body 16 at proximal end 12. However, connector cap 28 may be attachable to main body 16 via any connectors known to a person of ordinary skill in the art, including but not limited to cam locks, clamps, fasteners, Luer-lock mechanisms, and latches.

Connector cap 28 also includes port 30 providing access to feeding tube 26 (in an embodiment, connector cap 28 provides access to an internal lumen of a tubular structural support disposed within main body 16, such as lumen 42). As a result, feeding tube 26 can remain secured within lumen 42 of main body 16 and operate as a traditional feeding tube. In some embodiments, port 30 is configured to temporarily connect to a syringe, adapter, or other feeding component. For example, port 30 may be a female Luer-lock fitting configured to receive a male Luer-lock fitting, or vice versa. In embodiments, connector port 30 is configured to receive a port cover (not depicted) similar to those port covers found on traditional G-tubes. In some embodiments, the port cover is removably secured to proximal end 12 of main body 16 via a tether.

Returning primarily to FIGS. 1A-4 and 6, proximal end 12 of main body 16 includes retaining member 20 having a lateral expanse greater than an outer diameter of connector cap 28. Thus, retaining member 20 prevents feeding tube 26 from sliding further into a patient than intended. In addition, retaining member 20 defines an inner channel therethrough that is aligned with an inner channel defined by lumen 42; as such, the defined inner channel of retaining member 20 includes an associated diameter that is less than or equal to an inner diameter of lumen 42. As such, lumen 42 secures to retaining member 20 (such as by adhesion, molding, a unibody configuration, screws, pins, and other mechanical attachments common within the art) to form a continuous channel through main body 16 for the passage of an intact pill or nutrient through retaining member 20 and into lumen 42. In some embodiments, retaining member 20 includes a handle with an ergonomic shape to allow a health care provider or patient to grasp and hold intact product delivery assembly 10 more easily.

Likewise, distal end 14 of main body 16 includes anchor 22 configured to prevent lumen 42 and/or feeding tube 26 from unintentionally exiting the patient. Similar to retaining member 20, anchor 22 defines an inner channel therethrough that is aligned with the inner channel defined by lumen 42; as such, the defined inner channel of anchor 22 includes an associated diameter that is less than or equal to the inner diameter of lumen 42. As such, lumen 42 secures to anchor 22 (such as by adhesion, molding, a unibody configuration, screws, pins, and other mechanical attachments common within the art) to form a continuous channel through main body 16 for the passage of an intact pill or nutrient through lumen 42 and into anchor 22. Anchor 22 is preferably configured to laterally expand and retract upon manipulation by a health care provider, such as a surgeon. As such, anchor 22 has a retracted configuration and an expanded configuration, which will be described in greater detail in the sections below.

Moreover, in an embodiment, support collar 24 (see FIGS. 1A, 3 and 9 in particular) is disposed adjacent to distal end 14 of main body 26, with support collar 24 having an inner diameter that is greater than an outer diameter of lumen 42, such that lumen 42 is partially receivable within support collar 24, and such that lumen 42 can mate with anchor 22. In addition, the inner diameter of support collar 24 is less than or equal to an inner diameter of asymmetrical support 18 (described in greater detail below), such that asymmetrical support 18 secures to support collar 24 (such as by adhesion, molding, a unibody configuration, screws, pins, and other mechanical attachments common within the art). Support collar 24 includes a main body proximate to distal end 14 of assembly 10, and a shelf that is disposed adjacent to lumen 42, such that the shelf is disposed between distal end 14 and proximal end 12 of assembly 10. The main body of support collar 24 includes an outer diameter that is smaller than an inner diameter of anchor 22; as such, anchor 22 surmounts and is configured to receive support collar 24 through a central aperture of anchor 22. In addition, the shelf of support collar 24 includes an outer diameter that is greater than the inner diameter of anchor 22; as such, the shelf of support collar 24 prevents the translation of anchor 22 in a direction toward retaining member 20.

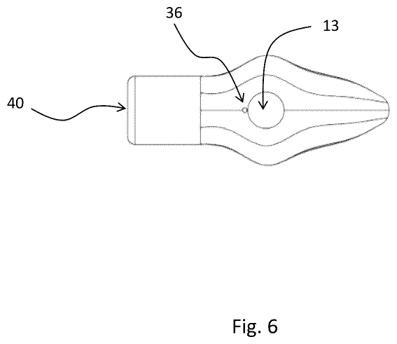

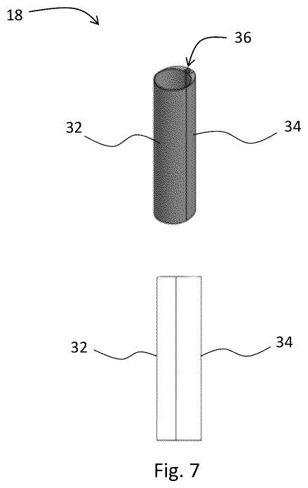

Referring in particular to FIGS. 3 and 7, an embodiment of assembly 10 includes asymmetrical support 18 that surrounds and receives lumen 42 therein. Asymmetrical support 18 is asymmetrical across a lateral expanse thereof, such that asymmetrical support 18 includes two half-cylinders that are inequal in volume, with one half-cylinder being greater in volume than the other half-cylinder. The smaller half-cylinder may be referred to as support section 32 of asymmetrical support 18, and the larger half-cylinder may be referred to as fluid flow section 34 of asymmetrical support 18. Together, support section 32 and fluid flow section 34 define an inner diameter of asymmetrical support 18; similarly, together, support section 32 and fluid flow section 34 define an internal channel therebetween. Since asymmetrical support 18 is asymmetric in shape, fluid flow section 34 includes a greater radius (defined from an outer surface thereof to a central axis of asymmetrical support 18) than an associated radius of support section 32. In some embodiments, as best depicted in FIGS. 4 and 6, fluid flow section 34 of asymmetrical support 18 includes anchor access channel 36 that is a separate channel/lumen from the internal channel defined by asymmetrical support 18 to maximize the area that intact pills can travel through lumen 42 and asymmetrical support 18. Anchor access channel 36 will be described in greater detail in the sections below.

In some embodiments, asymmetrical support 18 acts as a structural backbone for lumen 42. Thus, asymmetrical support 18 has greater rigidity/stiffness and/or less elasticity than lumen 42. These features may be achieved by using a material having greater rigidity/stiffness and/or less elasticity than the material of lumen 42 or through structural features that result in asymmetrical support 18 having greater rigidity/stiffness and/or less elasticity than lumen 42.

In some embodiments, fluid flow section 34 is shaped to have an internal surface that mates with the outer surface of support section 32. Some embodiments further include the outer surface of fluid flow section 34 having a curved designed to conform to the curvature of support section 32. In some embodiments, fluid flow section 34 and support section 32 are a single body, double-lumen component (such as being a silicone overmolded component).

In the provided figures, support section 32 has a generally half-cylindrical, tubular shape with a half-circular cross-sectional area. However, it is contemplated that some embodiments may have a tubular shape with a cross-sectional area that is not perfectly circular or is in the shape of an alternative polygonal shape. To ensure that outlet aperture 15 is properly located within the patient, support section 32 of asymmetrical support 18 has a length sufficient to position outlet aperture 15 at a predetermined location within the patient's stomach, or other preferred organ, such that any products (such as medication, solid nutrients, liquids, and other products typically implemented via a feeding tube) exiting lumen 42 are discharged in the predetermined location.

Because of the compromised rigidity of lumen 42, in some embodiments, the surrounding tissue could occlude lumen 42, thereby rendering it incapable of delivering food to the patient. To preempt this issue, feeding tube 26 includes structural support 27 (see FIG. 5 in particular). Structural support 27 has greater rigidity than lumen 42. In some embodiments, structural support 27 is configured to temporarily reside within lumen 42 and provide support from within main body 16. These embodiments therefore include a cross-sectional shape sufficiently sized to allow structural support 27 to enter lumen 42. However, some embodiments may include structural support 27 interconnected with an external surface of main body 16 or a portion of main body 16 outside of lumen 42.

In some embodiments, structural support 27 is tubular and acts as a traditional feeding tube. Thus, the sizes of the inner diameter, outer diameter, and wall thickness of the structural support 27 closely adhere to the sizes of traditional G-tubes. In some embodiments, structural support 27 has a smaller outer diameter than traditional G-tubes to fit more easily within lumen 42 of main body 16. Moreover, the wall thickness of some embodiments of structural support 27 is greater than the wall thickness of transcutaneous section 32 of main body 16.

Structural support 27 also includes the structural rigidity that is consistent with traditional G-tubes to ensure that the internal lumen of structural support 27 will not become occluded on account of the compression forces of the tissue surrounding the present invention when implanted. The rigidity of structural support 27 may be accomplished by manufacturing structural support 27 using materials that are typically used in manufacturing traditional G-tubes. A non-limiting list of materials includes PTFE, polyvinyl chloride (PVC), polyurethane, and silicone.

Structural support 27 further includes a length sufficient to at least extend distally beyond a terminal end of lumen 42 when structural support 27 is temporarily secured to main body 16. In some embodiments, the length of structural support 27 is sufficient to ensure that the distal end of structural support 27 reaches at least outlet aperture 15 of main body 16 when structural support 27 is temporarily secured to main body 16. In some embodiments, the length of structural support 27 is sufficient to ensure that the distal end of the structural support 27 extends past outlet aperture 15 of main body 16 when structural support 27 is temporarily secured to main body 16.

Some embodiments of feeding tube 26 further include friction reducing features, coatings, or materials disposed on the outer surface of structural support 27 to allow for easier insertion and removal of structural support 27. Likewise, some embodiments of the feeding tube 26 further include friction reducing features, coatings, or materials disposed on the internal surface of lumen 42 for the same reason.

Some embodiments of main body 16 further include additional annular supports located at proximal end/inlet aperture 12, 13 and at distal end/outlet aperture 14, 15. The annular supports provide greater rigidity at apertures 13, 15 to make it easier to insert structural support 27.

Some embodiments of main body 16 further include a one-way valve (e.g., a duck bill valve) within lumen 42 to prevent fluid from exiting the patient through lumen 42. In some embodiments, structural support 27 and/or connector cap 28 also includes a similar one-way valve for the same reason.

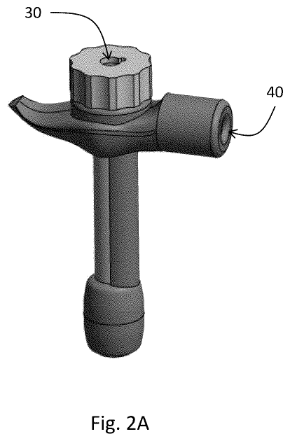

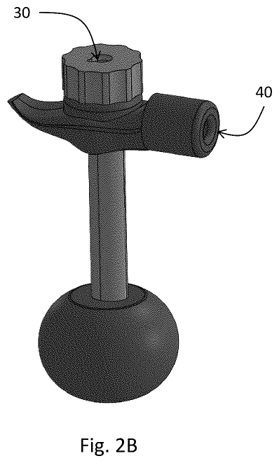

As noted above, anchor 22 has a retracted configuration and an expanded configuration. In the retracted configuration (see FIGS. 1A and 2A), a lateral expanse of anchor 22 is minimized to a similar size as the outer diameter of asymmetrical support 18, thereby minimizing the required size of the incision to allow anchor 22 to pass into the patient's body. In contrast, the expanded configuration (see FIGS. 1B and 2B) includes anchor 22 having a lateral expanse greater than the outer diameter of outer lumen 18, thereby preventing asymmetrical support 18, lumen 42, and/or feeding tube 26 from unintentionally exiting the patient's body. The main body of support collar 24 maintains a minimum inner diameter of anchor 22, such that the channel of main body 16 remains open including during expansion of anchor 22.

Returning to anchor access channel 36, in some embodiments, anchor access channel 36 is in fluidic or mechanical communication with anchor 22 at distal end 14 of assembly 10 (see FIGS. 6-8 in particular). In addition, in some embodiments, anchor access channel 36 is in fluidic or mechanical communication with and access port 40 (or valve 40) at proximal end 12 of assembly 10. In some embodiments, access port 40 is formed within retaining member 20, such that retaining member 20 provides indirect access to anchor 22 from an environment that is exterior to a subject. In an embodiment, support collar 24 includes an aperture defined therein that aligns with anchor access channel 36 to provide fluidic access to anchor 22. Anchor 22, anchor access channel 36, and access port 40 together form a closed loop within intact product delivery assembly 10, as will be discussed in greater detail below.

As noted above, anchor 22 includes a retracted configuration and an expanded configuration, such that anchor 22 can be selectively altered (such as through a lateral expanse thereof) depending on an implementation status of anchor 22. As such, anchor access channel 36 provides a health care provider, such as a surgeon, with a passage to convert anchor 22 between its retracted and expanded configurations.

In some embodiments, anchor 22 is an inflatable balloon. In such embodiments, anchor access channel 36 provides a fluidic passage through which pressurized air/fluid can pass from access port 40 to the inflatable balloon anchor 22. In embodiments, access port 40 also includes a valve or a port cover to prevent air/fluid from escaping the inflatable balloon anchor 22 when inflated. As such, via anchor access channel 36, air/fluid is selectively input and removed from anchor 22 to alter the configuration of anchor 22 between the retracted configuration (in which air/fluid is removed) and the expanded configuration (in which air/fluid is input).

However, alternative embodiments may use other known anchors 22 secured to distal end 14 of main body 16. For example, embodiments of anchor 22 are mechanically actuated, and anchor access channel 36 provides a passage through which a mechanical device can pass or permanently reside to interact with anchor 22. The mechanical device is configured to convert anchor 22 between its retracted and expanded configurations in a similar manner to that of the inflatable balloon anchor 22 as discussed above. In addition, in some embodiments, anchor 22 is a bumper stop that is designed for insertion within a subject, and that is expandable to a greater lateral expanse such that anchor 22 cannot be removed from the subject in the expanded configuration. In other embodiments, anchor 22 is a mechanical component that includes prongs that are parallel to the center axis of lumen 18 in a retracted configuration, and perpendicular to the center axis of lumen in an expanded configuration, thereby securing anchor 22 to a subject's stomach lining.

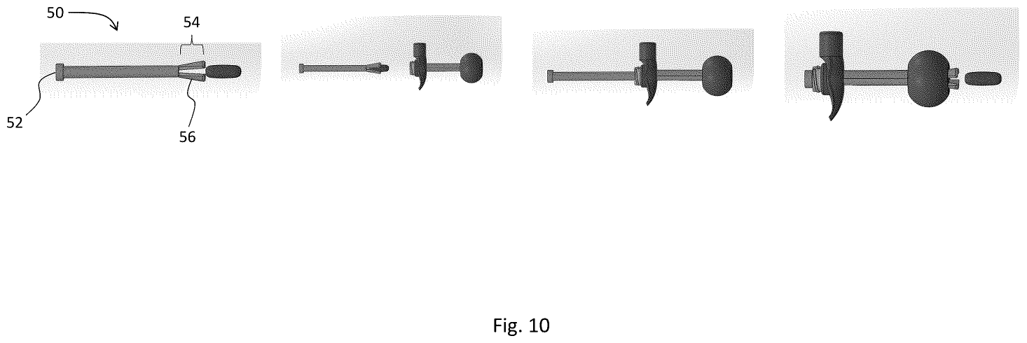

As exemplified in FIG. 10, some embodiments of the present invention include pill delivery device 50. Pill delivery device 50 includes handle section 52 at a proximal end thereof and either pushing surface 54 or grasping element 56 at a distal end thereof. In some embodiments, pill delivery device 50 has a proximal stop between the proximal and distal ends thereof, with the proximal stop having a lateral expanse greater than the diameter of inlet aperture 13 to prevent pill delivery device 50 from translating too far in a distal direction within lumen 42.

With the exception of the proximal stop, pill delivery device 50 has an outer diameter smaller than the inner diameter of lumen 42. As such, pill delivery device 50 can pass through lumen 42 when feeding tube 26 has been removed from lumen 42. Moreover, the length of pill delivery device 50 between the proximal stop and the distal end is equal to or greater than the length of lumen 42 to ensure that the pill exits outlet aperture 15. In some embodiments, the length of pill delivery device 50 is sufficient such that grasping element 56 exits outlet aperture 15 when pill delivery device 50 is fully inserted into lumen 42.

As previously stated, the distal end of pill delivery device 50 may include pushing surface 54. Pushing surface 54 may be a curved or blunted surface with rounded edges to avoid cutting or otherwise damaging the internal surface of lumen 42.

In contrast, some embodiments of pill delivery device 50 include pill grasping element 56. Pill grasping element 56 may be configured to mechanically grasp the pill through an actuator. In some embodiments, grasping element 56 includes compliant arms having a lateral expanse (or diameter) slightly larger than the diameter of inlet aperture 13, resulting from a bias (such as a spring). When grasping element 56 is inserted into lumen 42, the compliant arms are forced around the pill by the walls of lumen 42. When grasping element 56 exits distal aperture 15, the compliant arms spring open and release the pill within the patient. In other embodiments, pushing surface 54 and/or grasping element 56 includes a lateral expanse (or diameter) that is equal to or slightly smaller than the diameter of inlet aperture 13, without flexing or bias.

The present invention further includes a method of delivering intact products, such as medication or nutrients, to a patient. The method includes implanting at least a portion of assembly 10 as described above, such that at least a portion of transcutaneous section 32 of main body 16 resides within an incision in the patient's body. The expandable anchor 22 at distal end 14 of main body 16 is then inflated. In some embodiments, feeding tube 26, and particularly structural support 27, may be connected to main body 16 prior to implantation of assembly 10 within the patient.

When feeding tube 26 is used to deliver liquid or small solid nutrition to the patient, structural support 27 of feeding tube 26 is connected to main body 16. When a pill needs to be administered, structural support 27 of feeding tube 26 is removed from main body 16, and pill delivery device 50 is inserted into lumen 42 to translate an intact pill through lumen 42 and out of outlet aperture 15. As described above, handle section 52 may be used to manipulate pill delivery device 50 within main body 16. In addition, as described above, pill delivery device 50 can deliver the intact pill through outlet aperture 15 via pushing surface 54 or grasping element 56, depending on the orientation and structure of the distal end of pill delivery device 50. Pill delivery device 50 may then be removed from lumen 42, and structural support 27 of feeding tube 26 can be reinserted into lumen 42 and secured to main body 16.

It should also be noted that feeding tube 26 can be easily removed from lumen 42 for cleaning and unclogging structural support 27 after use as a feeding tube. As previously described herein, it can be extremely difficult to remove and clean or unclog a traditional G-tube. Thus, assembly 10 overcomes this issue through the use of the removable structural support 27.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. An intact consumable delivery assembly, the assembly comprising:
a main body spanning between a proximal end and a distal end;
a retaining member disposed at the proximal end of the main body, the retaining member defining an inlet aperture therethrough;
an anchor disposed at the distal end of the main body, the anchor defining an outlet aperture therethrough;
a lumen spanning from the retaining member to the anchor, the lumen secured to the retaining member at a first end and secured to the anchor at an opposing second end; and
a feeding tube including a structural support coupled to a connector cap, the connector cap having an outer diameter greater than an outer diameter of the structural support, the outer diameter of the structural support being less than an inner diameter of the lumen, such that the structural support is selectively receivable within the lumen,
wherein the feeding tube is configured to deliver an intact consumable to a subject via the outlet aperture.

2. The assembly of claim 1, further comprising an asymmetric support secured to the retaining member at a first end and secured to the anchor at an opposing second end, with the lumen being received within the asymmetric support, the asymmetric support including:
a first half-cylinder and a second half-cylinder, the first half-cylinder being a support section and the second half-cylinder being a fluid flow section, the fluid flow section and the support section together defining a channel therebetween, with the lumen received within the channel;
the fluid flow section defining an anchor access channel that is separate from the asymmetric support channel.

3. The assembly of claim 2, further comprising an access port defined within the retaining member, the access port being separate and spaced apart from the inlet aperture.

4. The assembly of claim 3, wherein the anchor access channel is in fluidic communication with the access port defined by the retaining member.

5. The assembly of claim 4, further comprising an inflation port defined by the anchor, wherein the anchor access channel is in fluidic communication with the inflation port, thereby creating a closed loop between the access port, the anchor access channel, and the inflation port.

6. The assembly of claim 2, wherein the asymmetric support is made of a first material and the lumen is made of a second material, the first material having a greater rigidity than the second material.

7. The assembly of claim 2, wherein the fluid flow section has a greater volume than the support section.

8. The assembly of claim 1, wherein the anchor includes a retracted configuration in which the anchor has a first outer diameter and an expanded configuration in which the anchor has a second outer diameter, the second outer diameter being greater than the first outer diameter.

9. The assembly of claim 1, wherein the anchor includes an interior compartment that is defined by at least one flexible wall, wherein the interior compartment is configured to increase and decrease in volume based on an input or a removal of fluid from the interior compartment.

10. The assembly of claim 1, further comprising a support collar surrounding at least a portion of the lumen, the support collar including a main body having an outer diameter that is less than an inner diameter of the anchor, such that the inner diameter of the anchor remains constant upon an increase or decrease in volume of the anchor.

11. The assembly of claim 10, further comprising a shelf connected to the main body, the shelf having an outer diameter that is greater than the inner diameter of the anchor, wherein the shelf prevents lateral translation of the anchor in a direction toward the retaining member.

12. The assembly of claim 1, further comprising a port defined within the connector cap, the port having a central axis that is aligned with the inlet aperture.

13. The assembly of claim 1, further comprising a threaded extension disposed at the proximal end of the body, the threaded extension extending in a direction away from the retaining member.

14. The assembly of claim 13, wherein the connector cap of the feeding tube engages with and secures to the threaded extension.

15. The assembly of claim 1, wherein the feeding tube is removable from the lumen, further comprising a pill delivery device including:
a main body having a first outer diameter that is less than the inner diameter of the outer lumen, such that the main body of the pill delivery device is receivable within the outer lumen; and
a pushing surface disposed at a distal end of the main body, the pushing surface having:
a biased configuration with a second outer diameter that is greater than the inner diameter of the lumen; and
an inserted configuration with a third outer diameter that is less than the inner diameter of the lumen;
the pushing surface configured to receive an intact pill,
wherein the pushing surface is configured to eject the intact pill through the outlet aperture of the main body upon transformation from the inserted configuration to the biased configuration.
